(19) United States
(12) Patent Application Publication
(10) Pub. No.: US 2025/0318688 A1
(43) Pub. Date: Oct. 16, 2025

(54) DOUGH MOLD END CAP ASSEMBLY FOR A STAND MIXER

(71) Applicant: Haier US Appliance Solutions, Inc., Wilmington, DE (US)

(72) Inventors: Danister Abeygunawardana, Jeffersonville, IN (US); Tomas Garces, Louisville, KY (US); Emily Rose Ashburn, Louisville, KY (US)

(21) Appl. No.: 18/636,980

(22) Filed: Apr. 16, 2024

(51) Int. Cl. A47J 43/07; A47J 43/044

(52) U.S. Cl. CPC A47J 43/0711; A47J 43/044; A47J 2043/0449

(57) ABSTRACT

A stand mixer includes a base, a support column, a head, and an auxiliary attachment assembly. The auxiliary attachment assembly includes a dough hopper including an inlet for receiving moldable dough and an outlet for releasing the moldable dough into a dough mold end cap assembly, a dough mover positioned within the hopper for conveying dough from the inlet to the outlet, and the end cap assembly for forming the dough. The end cap assembly is coupled to the hopper and includes an end cap covering the outlet, the end cap including an inlet for receiving the dough and an outlet for releasing the dough, and a dough mold rotatable relative to the end cap for forming the dough released from the outlet as the dough mold is rotated relative to the end cap.

### FIELD OF THE INVENTION

The present disclosure relates generally to stand mixers, or more specifically, to the dough mold end cap assembly of a stand mixer.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. Such utensil types connected to the driveshaft(s) often include various auxiliary attachments, such as dough forming attachments. The auxiliary attachments may include a dough mold end cap assembly that forms the dough into a final or molded shape. While such dough mold end cap assemblies work well, further improvements are needed.

Accordingly, a stand mixer having an improved dough mold end cap assembly would be desirable. More specifically, a dough mold end cap assembly for use with existing auxiliary attachments assemblies that is capable of molding or forming dough into cookie shapes for baking would be particularly beneficial.

### BRIEF DESCRIPTION OF THE INVENTION

Aspects and advantages of the invention will be set forth in part in the following description, or may be apparent from the description, or may be learned through practice of the invention.

In one example aspect, a stand mixer including a base, a support column coupled to the base and extending upwardly from the base, a head coupled to an upper end of the support column and extending from the support column above the base, and an auxiliary attachment assembly is provided. The auxiliary attachment assembly includes a dough hopper including a dough hopper inlet for receiving moldable dough therethrough and a dough hopper outlet for releasing the moldable dough into a dough mold end cap assembly, a dough mover positioned within the dough hopper for conveying the moldable dough from the dough hopper inlet to the dough hopper outlet, and the dough mold end cap assembly for forming moldable dough into a molded dough. The dough mold end cap is assembly is coupled to the dough hopper and includes an end cap covering the dough hopper outlet, the end cap including an end cap inlet for receiving the moldable dough conveyed by the dough mover and an end cap outlet for releasing the moldable dough therefrom, and a dough mold rotatable relative to the end cap for forming the moldable dough released from the end cap outlet into the molded dough as the dough mold is rotated relative to the end cap.

In another example aspect, an auxiliary attachment assembly for a stand mixer including a base, a support column coupled to the base and extending upwardly from the base, and a head coupled to an upper end of the support column and extending from the support column above the base is provided. The auxiliary attachment assembly includes a dough hopper including a dough hopper inlet for receiving moldable dough therethrough and a dough hopper outlet for releasing the moldable dough into a dough mold end cap assembly, a dough mover positioned within the dough hopper for conveying the moldable dough from the dough hopper inlet to the dough hopper outlet, and the dough mold end cap assembly for forming moldable dough into a molded dough. The dough mold end cap is assembly is coupled to the dough hopper and includes an end cap covering the dough hopper outlet, the end cap including an end cap inlet for receiving the moldable dough conveyed by the dough mover and an end cap outlet for releasing the moldable dough therefrom, and a dough mold rotatable relative to the end cap for forming the moldable dough released from the end cap outlet into the molded dough as the dough mold is rotated relative to the end cap.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an example embodiment of a stand mixer of the present disclosure.

FIG. 2 is a perspective view of the example stand mixer of FIG. 1 with an example embodiment of an auxiliary attachment assembly coupled to the stand mixer, the auxiliary attachment assembly with an example embodiment of a dough mold end cap assembly.

FIG. 3 is a perspective view of the example auxiliary attachment assembly and dough mold end cap assembly of FIG. 2.

FIG. 4 is a cross-sectional view of the example auxiliary attachment assembly and dough mold end cap assembly of FIG. 2 taken about line 4-4.

FIG. 5 is a perspective view of the example dough mold end cap assembly of FIG. 2.

FIG. 6 is a perspective view of the example dough mold end cap assembly of FIG. 2.

FIG. 7 is a front view of the example dough mold end cap assembly of FIG. 2.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

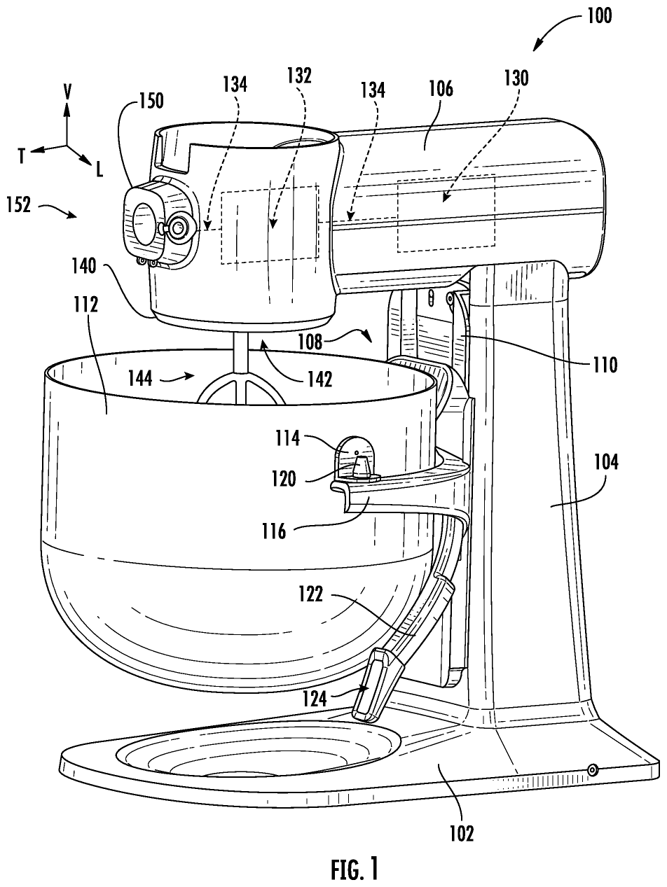

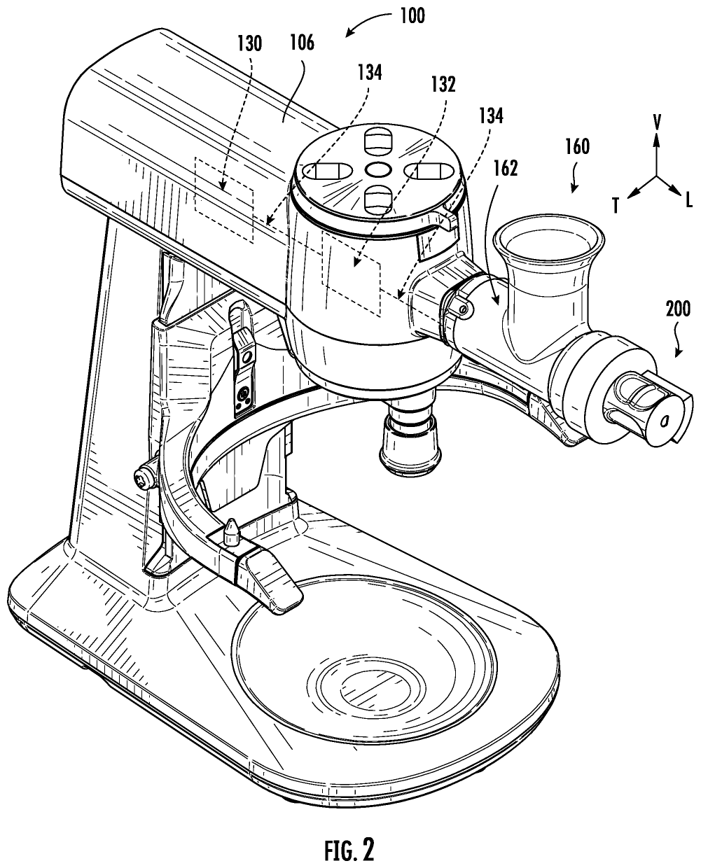

FIGS. 1 and 2 provide perspective views of a stand mixer 100 according to an example embodiment of the present subject matter. It will be understood that stand mixer 100 is provided by way of example only and that the present subject matter may be used in or with any suitable stand mixer in alternative example embodiments. Moreover, with reference to each of FIGS. 1 and 2, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

Stand mixer 100 may include a base 102 and a support post or column 104. Column 104 may include a bowl support 108. Bowl support 108 may slidably mount to a column rail 110, which is mounted to column 104. Additionally, components of bowl support 108 may extend outwardly above the base 102, e.g., in the transverse direction T, and may hold bowl 112 above base 102, e.g., along the vertical direction V. Bowl 112 may be removably mounted on bowl support 108 via flanges 114. Flanges 114 may be on opposite sides of the bowl 112 with respect to the circumference of the bowl.

Additionally, the support column 104 may support a mixer head 106, which is positioned atop column 104. The mixer head 106 may house a motor 130, a gearbox 132, and/or a drivetrain apparatus 134 of stand mixer 100. For example, as shown in FIG. 1, head 106 may be mounted to column 104, which is mounted to base 102. Thus, column 104 may extend between and connect base 102 and head 106, e.g., along the vertical direction V. Head 106 may extend outwardly above the base 102, e.g., in the transverse direction T.

Furthermore, head 106 includes a mixing attachment support 140. Mixing attachment support 140 is located on a lower portion or underside 142 of head 106 and forward of support column 104 along transverse direction T. A rotating mixing attachment 144 is removably coupled to the mixing attachment support 140. The drivetrain apparatus 134 connects the motor 130 with the gearbox 132 and the mixing attachment support 140 such that the motor 130 may drive rotation of the mixing attachment 144 when the mixing attachment 144 is coupled to the mixing attachment support 140. The gearbox 132 may allow user selection of different rotating speeds for the mixing attachment 144. The stand mixer 100 may include one or more controls for operations such as selectively powering the motor 130, choosing the speed of rotation for the mixing attachment 144, and other features. In certain embodiments, the mixing attachment support 140 may accept more than one type of mixing attachment 144. Various types of mixing attachments may be used including e.g., whisks, paddles, dough hooks, beaters, and others for purposes of mixing ingredients within a bowl or other container supported by the base 102. During use, rotation of the mixing attachment 144 may be driven in a circular or planetary manner. Spinning in a planetary manner, as used herein, includes spinning both in a circular manner and rotating about an axis that moves in a circular manner. In some embodiments, the motor 130 may be disposed within base 102, including within the column 104.

Example operation of an exemplary embodiment of the stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on a motor to begin the process of mixing, kneading, beating, etc. The motor rotates an attachment attached to stand mixer 100 to complete each of these processes. The processes may be conducted with a respective attachment such as a mixer blade for mixing, a dough hook for kneading, and a balloon whisk for beating.

As shown in FIG. 1, bowl support 108 may include an arm 116, with a mounting spike 120. Arm 116 may hold bowl 112 via mounting spike 120, which may removably couple to flanges 114. For instance, each mounting spike 120 on arm 116 may be received within a respective flange 114 on bowl 112. Lift lever 122 may rotatably couple to arm 116. There may be at least two lift levers 122. Thus, bowl 112 may be disposed between lift levers 122, e.g., along the lateral direction L. Each lift lever 122 may be positioned on a respective side of bowl 112, such that both a left-handed user and a right-handed user may comfortably operate lift levers 122. Lift lever 122 may have one end 124 cantilevered from support column 104. Such distal end 124 may correspond to a handle for a user to grasp, push, or pull.

Furthermore, as best illustrated in FIGS. 1 and 2, the head 106 includes an auxiliary attachment support 150 located on a forward portion or frontside 152 of head 106 in the transverse direction T and forward of support column 104 in the transverse direction T. An auxiliary attachment assembly 160 (FIG. 2) including a dough mold end cap assembly 200 (FIG. 2) for molding or forming cookie dough, is removably coupled to the auxiliary attachment support 150. For example, a removable pin (not shown) may couple the auxiliary attachment assembly 160 to the auxiliary attachment support 150. The drivetrain apparatus 134 connects the motor 130 with the gearbox 132 and the auxiliary attachment support 150 such that the motor 130 may drive rotation of various components of the auxiliary attachment assembly 160 (FIG. 2) when the auxiliary attachment assembly 160 (FIG. 2) is coupled to the auxiliary attachment support 150. In certain embodiments, the auxiliary attachment support 150 may accept more than one type of auxiliary attachment assembly. For example, various types of auxiliary attachment assemblies may be used including e.g., pasta extruders, and others for purposes of molding or forming dough into molded shapes or otherwise processing food.

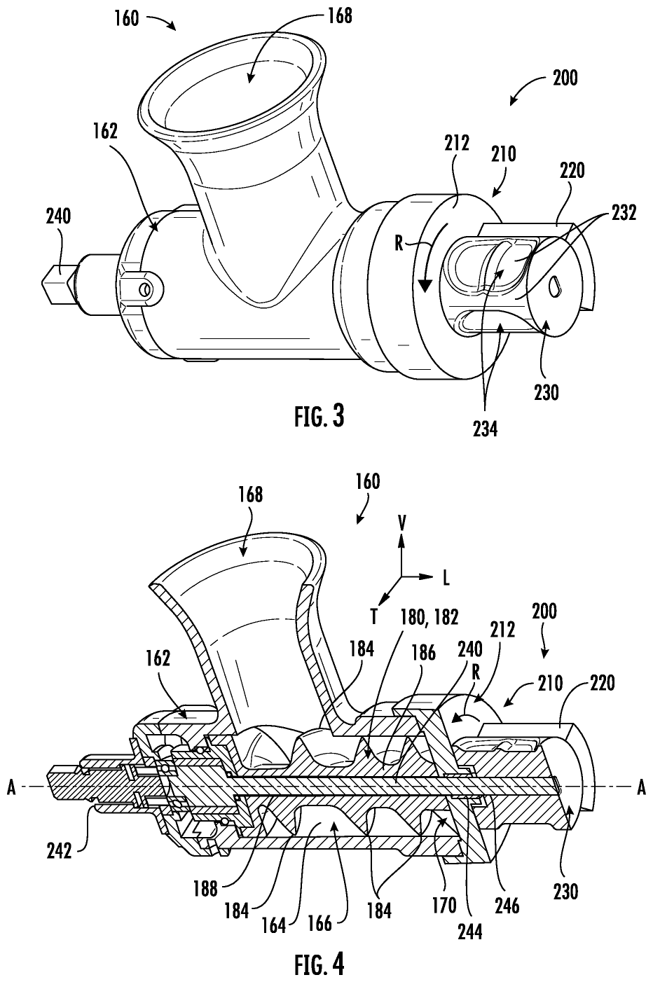

Referring now to FIGS. 2 through 7, the auxiliary attachment assembly 160, including the dough mold end cap assembly 200, that may be used with the stand mixer 100 will be described according to example embodiments of the present subject matter.

According to example embodiments, the auxiliary attachment assembly 160 may include a dough hopper 162, which, as will be described below, may also house various other components of the auxiliary attachment assembly 162. As best illustrated in FIG. 4, the dough hopper 162 includes an inner wall 164 that defines an interior portion 166 of the dough hopper 162. Additionally, the dough hopper 162 includes a dough hopper inlet 168 for receiving the moldable dough within the interior portion 166 of the dough hopper 162 through which it will travel toward the dough mold end cap assembly 200 to be formed into molded dough. The dough hopper 162 also includes a dough hopper outlet 170 for releasing the moldable dough from the interior portion 166 of the dough hopper 162 into the dough mold end cap assembly 200. The dough hopper inlet 168 may be an inlet opening defined by the dough hopper 162 for receiving the moldable dough and the dough hopper outlet 170 may be an outlet opening defined by the dough hopper 162 for releasing the moldable dough therefrom.

According to example embodiments, the auxiliary attachment assembly 160 may include a dough mover 180 for conveying the moldable dough from the dough hopper inlet 168 to the dough hopper outlet 170 to be released into the dough end cap assembly 200. As best illustrated in FIG. 4, the dough mover 180 may be positioned within the interior portion 166 of the dough hopper 162. The dough mover 180 may be a rotatable auger 182 rotatable about an axis A and a plurality of auger threads 184 extending along an axial shaft 186. As will be described below, the rotatable auger 182 may define an auger drive shaft cavity 188 therein for receiving a drive shaft 240 of the auxiliary attachment assembly 160 therein for rotating the rotatable auger 182 about the axis A. Additionally, the auxiliary attachment assembly 160 may be coupled to the head 106 of the stand mixer 100 such that the dough hopper inlet 168 is positioned above the rotatable auger 182. As such, the moldable dough may be received by the rotatable auger 182 from the dough hopper inlet 168. As the auger 182 rotates, the moldable dough is moved along the interior portion 166 of the dough hopper 162 in the longitudinal direction L by the auger threads 184 toward the dough hopper outlet 170.

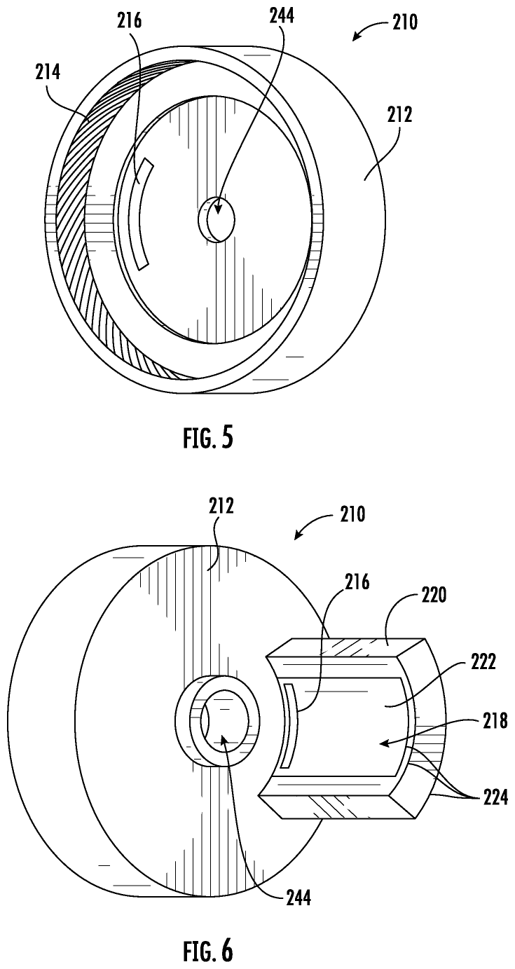

According to example embodiments, the auxiliary attachment assembly 160 may include the dough mold end cap assembly 200 mentioned previously for forming the moldable dough released from the dough hopper outlet 170 into molded dough. The dough mold end cap assembly 200 may be removably coupled to the dough hopper 162 such that the dough mold end cap assembly 200 may be washed or otherwise cleaned or replaced with an alternative type of end cap assembly for use with the auxiliary attachment assembly 160. In this respect, as best illustrated in FIGS. 4 through 6, the dough mold end cap assembly 200 may include an end cap 210 including a cap portion 212 including a plurality of end cap threads 214 (FIG. 5) for removably coupling the dough mold end cap assembly 200 to the dough hopper 162. The cap portion 212 may cover the dough hopper outlet 170 (FIG. 4) to prevent dough from escaping the dough hopper 162.

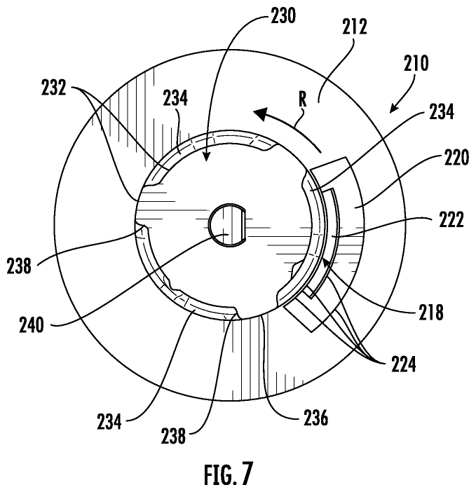

According to example embodiments, the end cap 210 may include an end cap inlet 216 (FIGS. 5, 6) for receiving the moldable dough conveyed by the dough mover 180 and an endcap outlet 218 (FIGS. 6, 7) for releasing the moldable dough therefrom. Additionally, the end cap 210 may include an axial extension 220 protruding from the cap portion 212. The axial extension 220 may define a dough receiving cavity 222 (FIGS. 6, 7) therein for receiving the moldable dough conveyed by the dough mover 180. As such, the axial extension 220 may be positioned over the end cap inlet 216 (FIG. 6) such that the moldable dough is received within the dough receiving cavity 222 of the axial extension. Furthermore, the axial extension 220 may include the endcap outlet 218 for releasing the moldable dough from the dough receiving cavity 222. Moreover, the axial extension 220 may be a curved or arcuate axial extension and, thus, the dough receiving cavity 222 may be a curved or acuate dough receiving cavity defining an axial extension curvature 224. As will be described below, the curvature 224 may be substantially similar to a curvature of a rotatable dough mold 230 of the dough mold end cap assembly 220 such that the dough mold 230 may rotate in a direction R relative to the end cap 210 for forming the moldable dough into molded dough.

According to example embodiments, the dough mold end cap assembly 200 may include the dough mold 230 for forming the moldable dough into the molded dough. As best illustrated in FIGS. 4 and 7, the dough mold 230 may be rotatable about the axis A relative to the axial extension 220 of the end cap 210 in the direction R for forming the moldable dough released from the dough hopper outlet 170 into the molded dough as the dough mold 230 is rotated relative to the axial extension 220. In this respect, the dough mold 230 may define a cylinder that includes an outer radial surface 232 in which one or more mold cavities 234 are defined.

Additionally, as best illustrated in FIG. 7, the outer radial surface 232 of the dough mold 230 may define a dough mold curvature 236 substantially similar or the same as the axial extension curvature 224. As such, the dough mold cavity(ies) 234 of the dough mold 230 may interface with the dough receiving cavity 222 of the axial extension 220 by receiving the moldable dough from the dough receiving cavity 222 when the dough mold cavity(ies) 234 face the dough receiving cavity 222, and forming the moldable dough into the molded dough as the dough mold cavity(ies) 234 are rotated past the dough receiving cavity 222 during rotation of the dough mold 230. In this respect, the dough mold cavity(ies) 234 may include various patterns (e.g., stars, smiley faces, etc.) for forming the moldable dough into molded dough as the dough mold 230 is rotated relative to the axial extension 220 of the end cap 210. Furthermore, each mold cavity 234 may be surrounded by one or more cavity walls 238 for cutting the dough into individual molded dough pieces, such as individual molded cookie dough pieces for baking. In this respect, the cavity wall(s) 238 may be a blade or other cutting mechanism. Each cavity wall 238 may define one of various shapes (e.g., circle, square, etc.) such that the individual molded dough pieces are cut into the corresponding shape.

According to example embodiments, the auxiliary attachment assembly 160 may also include the drive shaft 240 rotatable about the axis A and coupled to the dough mold 230 such that rotation of the drive shaft 240 results in rotation of the dough mold 230 with the drive shaft 240. As best illustrated in FIG. 4, the dough hopper 162 may define a hopper drive shaft opening 242 for receiving the drive shaft 240 therethrough. Furthermore, the end cap portion 212 of the end cap 210 of the dough mold end cap assembly 200 defines an end cap drive shaft opening 244 aligned with the hopper drive shaft opening 242 for receiving the drive shaft 240 therethrough when the dough mold end cap assembly 200 is coupled to the dough hopper 162. Additionally, a drive shaft chamber 246 may be defined within the dough mold 240 and aligned with the hopper drive shaft opening 242 and the end cap drive shaft opening 244 for receiving a portion of the drive shaft 240 therein. In this respect, the drive shaft 240 is coupled to the dough mold 230 through the end cap drive shaft opening 244. The drive shaft chamber 246 and the drive shaft 240 may have complementary cross-sectional shapes, such as “D” shapes best illustrated in FIG. 7, or rectangular shapes, that allow the drive shaft 240 to pull or rotate the dough mold 230 simultaneously with the drive shaft 240. Additionally, the complementary cross-sectional shapes of the drive shaft chamber 246 and the drive shaft 240 may limit or prevent the dough mold 230 and the drive shaft 240 from rotating relative to each other during simultaneous rotation. Furthermore, as best illustrated in FIG. 2, the drive shaft 240 may be coupled to the drivetrain apparatus 134 of the stand mixer 100 such that the motor 130 of the stand mixer 100 drives rotation of the drive shaft 240 and, thus, the dough mold 230.

As explained herein, aspects of the present subject matter are generally directed to an auxiliary attachment assembly of a stand mixer that includes a dough mold end cap assembly. The auxiliary attachment assembly includes a dough hopper for receiving moldable dough, such as moldable cookie dough, a dough mover for conveying the moldable dough through the dough hopper, and the dough mold end cap assembly coupled to the dough hopper for forming the moldable dough into molded dough. In addition, the dough mold end cap assembly includes an end cap for receiving the moldable dough conveyed through the dough hopper into a cavity of an axial extension of the end cap. The dough mold end cap assembly also includes a rotatable dough mold driven by the motor of the stand mixer and defining one or more mold cavities for forming and cutting the moldable dough into molded dough as the dough mold. The dough mold and the axial extension of the end cap may define substantially similar curvatures such that the dough mold may rotate relative to the axial extension to form the moldable dough received from the cavity of the axial extension into molded dough, such as individual molded cookie dough pieces for baking. This dough mold end cap assembly that is usable with an auxiliary attachment of a stand mixer may advantageously provide molding or forming cookie dough into cookie shapes for baking so that separate tools/machinery are not necessary. Additionally, the dough mold end cap assembly is removably coupled to the auxiliary attachment assembly. In this respect, a user may thus use the machinery they already own or have access to (i.e., stand mixer, auxiliary attachment assembly) to mold cookie dough.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer, comprising:
a base;
a support column coupled to the base and extending upwardly from the base;
a head coupled to an upper end of the support column and extending from the support column above the base; and
an auxiliary attachment assembly, the auxiliary attachment assembly comprising:
a dough hopper including a dough hopper inlet for receiving moldable dough therethrough and a dough hopper outlet for releasing the moldable dough into a dough mold end cap assembly;
a dough mover positioned within the dough hopper for conveying the moldable dough from the dough hopper inlet to the dough hopper outlet; and
the dough mold end cap assembly for forming moldable dough into a molded dough, the dough mold end cap assembly coupled to the dough hopper, the dough mold end cap assembly comprising:
an end cap covering the dough hopper outlet, the end cap including an end cap inlet for receiving the moldable dough conveyed by the dough mover and an end cap outlet for releasing the moldable dough therefrom; and
a dough mold rotatable relative to the end cap for forming the moldable dough released from the end cap outlet into the molded dough as the dough mold is rotated relative to the end cap.

2. The stand mixer of claim 1, wherein:
the dough mold defines a mold cavity for forming the moldable dough into the molded dough as the dough mold is rotated relative to the end cap.

3. The stand mixer of claim 1, the end cap of the dough mold end cap assembly further comprising:
a cap portion for covering the dough hopper outlet, the cap portion including the end cap inlet; and
an axial extension protruding from the cap portion and including the end cap outlet for releasing the moldable dough from the dough receiving cavity; and
wherein:
the dough mold forms the moldable dough released from the end cap outlet into the molded dough as the dough mold is rotated relative to the axial extension of the end cap.

4. The stand mixer of claim 3, wherein the axial extension defines a dough receiving cavity therein, the axial extension positioned over the end cap inlet for receiving the moldable dough conveyed by the dough mover within the dough receiving cavity.

5. The stand mixer of claim 4, the dough mold of the dough mold end cap assembly comprising:
an outer radial surface in which a mold cavity is defined to interface with the dough receiving cavity of the axial extension.

6. The stand mixer of claim 5, wherein:
the mold cavity of the dough mold receives the moldable dough from the dough receiving cavity of the axial extension and forms the moldable dough into the molded dough as the dough mold is rotated past the dough receiving cavity of the axial extension.

7. The stand mixer of claim 5, wherein:
the outer radial surface of the dough mold defines a curvature; and
the axial extension is an arcuate axial extension and the dough receiving cavity of the axial extension is an arcuate dough receiving cavity defining a curvature substantially similar to the curvature of the outer radial surface of the dough mold.

8. The stand mixer of claim 1, the auxiliary attachment assembly further comprising:
a rotatable drive shaft coupled to a motor of the stand mixer for driving rotation of the rotatable drive shaft, the rotatable drive shaft further coupled to the dough mold of the dough mold end cap assembly such that rotation of the drive shaft results in rotation of the dough mold with the drive shaft.

9. The stand mixer of claim 8, wherein:
the end cap of the dough mold end cap assembly defines a drive shaft opening for receiving the rotatable drive shaft therethrough, the rotatable drive shaft coupled to the dough mold through the drive shaft opening of the end cap.

10. The stand mixer of claim 1, wherein the dough mold end cap assembly is removably coupled to the dough hopper of the auxiliary attachment assembly.

11. The stand mixer of claim 10, the end cap of the dough mold end cap assembly comprising:
a plurality of threads for removably coupling the dough mold end cap assembly to the dough hopper.

12. An auxiliary attachment assembly for a stand mixer, the stand mixer including a base, a support column coupled to the base and extending upwardly from the base, and a head coupled to an upper end of the support column and extending from the support column above the base, the auxiliary attachment assembly comprising:
a dough hopper including a dough hopper inlet for receiving moldable dough therethrough and a dough hopper outlet for releasing the moldable dough into a dough mold end cap assembly;
a dough mover positioned within the dough hopper for conveying the moldable dough from the dough hopper inlet to the dough hopper outlet; and
the dough mold end cap assembly for forming moldable dough into a molded dough, the dough mold end cap assembly coupled to the dough hopper, the dough mold end cap assembly comprising:
an end cap covering the dough hopper outlet, the end cap including an end cap inlet for receiving the moldable dough conveyed by the dough mover and an end cap outlet for releasing the moldable dough therefrom; and
a dough mold rotatable relative to the end cap for forming the moldable dough released from the end cap outlet into the molded dough as the dough mold is rotated relative to the end cap.

13. The auxiliary attachment assembly of claim 12, wherein:
the dough mold of the dough mold end cap assembly defines a mold cavity for forming the moldable dough into the molded dough as the dough mold is rotated relative to the end cap.

14. The auxiliary attachment assembly of claim 12, the end cap of the dough mold end cap assembly further comprising:
a cap portion for covering the dough hopper outlet, the cap portion including the end cap inlet; and
an axial extension protruding from the cap portion and including the end cap outlet for releasing the moldable dough from the dough receiving cavity; and
wherein:
the dough mold forms the moldable dough released from the end cap outlet into the molded dough as the dough mold is rotated relative to the axial extension of the end cap.

15. The auxiliary attachment assembly of claim 14, wherein the axial extension of the end cap of the dough mold end cap assembly defines a dough receiving cavity therein, the axial extension positioned over the end cap inlet for receiving the moldable dough conveyed by the dough mover within the dough receiving cavity.

16. The auxiliary attachment assembly of claim 15, the dough mold of the dough mold end cap assembly comprising:
an outer radial surface in which a mold cavity is defined to interface with the dough receiving cavity of the axial extension.

17. The auxiliary attachment assembly of claim 16, wherein:
the mold cavity of the dough mold receives the moldable dough from the dough receiving cavity of the axial extension and forms the moldable dough into the molded dough as the dough mold is rotated past the dough receiving cavity of the axial extension.

18. The auxiliary attachment assembly of claim 16, wherein:
the outer radial surface of the dough mold defines a curvature; and
the axial extension is an arcuate axial extension and the dough receiving cavity of the axial extension is an arcuate dough receiving cavity defining a curvature substantially similar to the curvature of the outer radial surface of the dough mold.

19. The auxiliary attachment assembly of claim 12, the auxiliary attachment assembly further comprising:
a rotatable drive shaft coupled to a motor of the stand mixer for driving rotation of the rotatable drive shaft, the rotatable drive shaft further coupled to the dough mold of the dough mold end cap assembly such that rotation of the drive shaft results in rotation of the dough mold with the drive shaft.

20. The auxiliary attachment assembly of claim 19, wherein:
the end cap of the dough mold end cap assembly defines a drive shaft opening for receiving the rotatable drive shaft therethrough, the rotatable drive shaft coupled to the dough mold through the drive shaft opening of the end cap.
